(19) United States
(12) Patent Application Publication
(10) Pub. No.: US 2026/0212360 A1
(43) Pub. Date: Jul. 23, 2026

(54) COMPUTER SYSTEMS AND METHODS FOR IDENTIFYING FRAUDULENT ACTIVITY USING KNOWLEDGE GRAPHS

(71) Applicant: Capital One Financial Corporation, McLean, VA (US)

(72) Inventors: Zhen Yuan, Arlington Heights, IL (US); Qingni Yu, Vernon Hills, IL (US)

(21) Appl. No.: 19/029,657

(22) Filed: Jan. 17, 2025

(51) Int. Cl. G06Q 20/40

(52) U.S. Cl. CPC G06Q 20/4016

(57) ABSTRACT

A computing platform configured to: (i) obtain information for a plurality of processed applications, wherein the obtained information includes a respective set of attributes for each processed application, (ii) create a knowledge graph to represent linkages between the processed applications, wherein the knowledge graph includes (a) a respective application node for each of the processed applications and (b) one or more edges connecting application nodes, wherein each edge represents one or more shared attributes between connected application nodes, and (iii) based on an analysis of the knowledge graph: (a) generate feature data for the application nodes, (b) identify a fraud ring comprising a group of application nodes within the knowledge graph, and (c) train a fraud identification model to identify new fraudulent applications.

### BACKGROUND

Financial institutions provide various kinds of financial services, including, among other things, enabling customers to create accounts with the financial institutions for managing financial activity. These accounts may take various forms, such as credit accounts, checking accounts, and saving accounts, among other examples.

To create an account with a financial institution, an entity may submit an application to the financial institution. The application may include identification information for the entity, as well as financial asset information, income information, job status information, etc. Upon receiving an application, the financial institution may process the application by either approving the application—and then creating an account based on the approved application—or by declining the application—in which case no account will be created for the application.

### OVERVIEW

Disclosed herein is new technology for utilizing knowledge graphs to identify new fraudulent applications for credit accounts, among other possible types of financial accounts, that are submitted with false identification information.

In one aspect, the disclosed technology may take the form of a method to be carried out by a computing platform that involves (i) obtaining information for a plurality of processed applications, wherein the obtained information includes a respective set of attributes for each processed application, (ii) creating a knowledge graph to represent linkages between the processed applications, wherein the knowledge graph includes (a) a respective application node for each of the processed applications and (b) one or more edges connecting application nodes, wherein each edge represents one or more shared attributes between connected application nodes, and (iii) based on an analysis of the knowledge graph: (a) generating feature data for the application nodes, (b) identifying a fraud ring comprising a group of application nodes within the knowledge graph, and (c) training a fraud identification model to identify new fraudulent applications.

In some example embodiments, the method may further involve, based on the analysis of the knowledge graph, generating feature data for the identified fraud ring. And in such example embodiments, the functionality for training the fraud identification model may take various forms. As one example, the functionality for training the fraud identification model may involve (i) providing input data to one or more model training techniques for training the fraud identification model, wherein the input data includes at least one of the knowledge graph, the feature data for the application nodes, or the feature data for the identified fraud ring. As another example, where the input data is first input data, the functionality for training the fraud identification model may further involve (ii) after providing the first input data to the one or more model training techniques for training the fraud identification model, updating at least one of the knowledge graph, the feature data for the application nodes, or the feature data for the identified fraud ring, and (iii) thereafter providing second input data to the one or more model training techniques for training the fraud identification model, wherein the second input data includes at least one of the updated knowledge graph, the updated feature data for the application nodes, or the updated feature data for the identified fraud ring.

Further, the obtained information may take various forms. For instance, in some example embodiments, the obtained information may include, for each of the processed applications, a respective decision status indication of whether the processed application has been declined or approved. And in some implementations of such example embodiments, the functionality of generating the feature data for the application nodes may involve generating the feature data for the application nodes further based on the decision status indications for the processed applications.

Further yet, in some example embodiments, the fraud identification model may be configured to output a set of rules for identifying new fraud applications.

Further yet, in some example embodiments, the method may further involve storing the knowledge graph in memory.

Further yet, in some example embodiments, the knowledge graph may further include (iii) attribute nodes corresponding to the sets of attributes for the processed applications.

In another aspect, the disclosed technology may take the form of a computing platform comprising at least one processor, at least one non-transitory computer-readable medium, and program instructions stored on the at least one non-transitory computer-readable medium that, when executed by the at least one processor, cause the computing platform to carry out the functions of the aforementioned method.

In yet another aspect, the disclosed technology may take the form of a non-transitory computer-readable medium comprising program instructions stored thereon that are executable to cause a computing platform to carry out the functions of the aforementioned method.

It should be appreciated that many other features, applications, embodiments, and variations of the disclosed technology will be apparent from the accompanying drawings and from the following detailed description. Additional and alternative implementations of the structures, systems, non-transitory computer readable media, and methods described herein can be employed without departing from the principles of the disclosed technology.

### BRIEF DESCRIPTION OF THE DRAWINGS

FIG. 1 depicts an example network configuration in which example embodiments may be implemented.

FIG. 2 depicts an example flow diagram of an example process that may be carried out to perform a learning phase in accordance with the present disclosure.

FIG. 3 depicts an example representation of a knowledge graph that may be created in accordance with the present disclosure.

FIG. 4 depicts an example representation of a transformed knowledge graph that may be created in accordance with the present disclosure.

FIG. 5 depicts an example representation of a knowledge graph in accordance with the present disclosure.

FIG. 6 depicts an example flow diagram of an example process that may be carried out to perform an evaluation phase in accordance with the present disclosure.

FIG. 7 depicts a simplified block diagram that illustrates some structural components of an example computing platform that may be configured to carry out any of the various functions disclosed herein.

FIG. 8 depicts a simplified block diagram that illustrates some structural components of an example client device that may be configured to carry out any of the various functions disclosed herein.

Features, aspects, and advantages of the presently disclosed technology may be better understood with regard to the following description, appended claims, and accompanying drawings, as listed below. The drawings are for the purpose of illustrating example embodiments, but those of ordinary skill in the art will understand that the technology disclosed herein is not limited to the arrangements and/or instrumentality shown in the drawings.

### DETAILED DESCRIPTION

The following disclosure makes reference to the accompanying figures and several example embodiments. One of ordinary skill in the art should understand that such references are for the purpose of explanation only and are therefore not meant to be limiting. Part or all of the disclosed systems, devices, and methods may be rearranged, combined, added to, and/or removed in a variety of manners, each of which is contemplated herein.

Financial institutions provide various kinds of financial services, including, among other things, enabling customers to create accounts with the financial institutions for managing financial activity. These accounts may take various forms, such as credit accounts, checking accounts, and saving accounts, among other examples.

To create an account with a financial institution, an entity may submit an application to the financial institution. The application may include (i) identification information for the entity, such as the entity's name, phone number, email address, social security number (SSN), and/or physical address, (ii) identification information for a client device operated by the entity to submit the application (e.g., a device ID, an IP address, etc.), and/or (iii) financial status information for the entity, such as financial asset information, income information, job status information, among other types of information.

Upon receiving an application, the financial institution may process the application either by approving the application—and then creating an account based on the approved application—or by declining the application—in which case no account will be created for the application. The financial institution may process the application based on the information included in the application, as described above.

Once an entity has opened an account with a financial institution, the entity may obtain credential information for managing financial activity associated with the account. For instance, an owner of a credit account may use the credential information for their credit account to make purchases and to deposit funds into the credit account, among other things.

One issue that plagues financial institutions is that of fraudulent activity, such as account creation fraud and transaction fraud, among other examples. As used herein, account creation fraud refers to the creation of an account based on an application that is submitted with false identification information, which may either be made up or stolen from someone else (e.g., identity theft). This is particularly impactful for credit accounts, because if a fraudster is able to create a credit account using false identification information, then they may be enabled to use the credit account to make purchases using the credit assigned to the credit account, without depositing any money to pay off the credit balance. And because the credit account was created based on false identification information, it may be difficult for the financial institution to identify the fraudster and recover their losses. Further, as used herein, transaction fraud refers to a transaction that is made based on false credential information, which may either be made up or solen from someone else (e.g., identity theft).

These issues are further amplified by the collusion of fraudsters in fraud rings, which refers to a group of fraudsters that commit financial fraud together, e.g., by sharing illegally obtained identification or credential information. For instance, fraudsters colluding in a fraud ring may work together to test different combinations of identification information for creating fraudulent accounts, as well as to test different combinations of credential information for making fraudulent transactions, among other examples. Because fraud rings are often made up of complex networks of individuals and organizations, they are able to distribute their fraudulent information, making it difficult for financial institutions to identify the perpetrators.

Financial institutions have attempted various methods to improve fraud detection, including fraud ring identification. For instance, one such method involves storing account application information within database tables for analysis, where pattern detection may be applied to the account application information to identify fraud. However, while such methods may be workable for identifying fraud on a small scale, the complexity that is introduced by fraud rings renders these methods unable to reliably detect fraudulent activity.

Some existing technology has emerged that identifies fraud rings by analyzing transaction information using a knowledge graph, where the transaction information is represented in the knowledge graph as nodes, and where edges between the nodes represent linkages between the nodes. However, the existing technology suffers from various shortcomings. As a result, financial institutions using the existing technology are still unable to detect fraudulent activity and identify fraud rings accurately and efficiently.

First, the existing technology is directed to identifying fraud rings based only on an analysis of transaction information, and is not equipped to identify fraud rings based on account application information. While identifying fraud at the transaction level is useful, often at that point the financial institution has already incurred financial loss, which may be difficult to recuperate.

Second, the knowledge graphs used by existing technology are stored in third-party graph databases, and are difficult to interact with. For instance, in order for a user to add information to a knowledge graph using existing technology, the user must interface with APIs configured for the third-party graph database. These APIs offer limited functionality, and as a result the user is not able to format the structure of the knowledge graph outside of the limited functionality offered via the APIs. Similarly, the existing technology only offers limited functionality for generating feature data based on knowledge graphs, which again, is limited by the APIs and the third-party graph databases. As such, it is difficult for users to apply knowledge domain experience to knowledge graphs to generate meaningful feature data, resulting in less precise and less effective fraud identification solutions.

Third, scaling knowledge graphs using the existing technology is problematic, because the connection between a client device and a third-party graph database may become unreliable as knowledge graphs stored within the third-party graph database are scaled. As a result, users may not be able to use the existing technology for larger knowledge graphs.

The existing technology has various other shortcomings as well.

To address these and other problems, disclosed herein is a new software pipeline for utilizing knowledge graphs to identify new fraudulent applications, which may refer to applications for credit accounts, among other possible types of accounts, that are submitted with false identification information, in line with the previous discussion.

At a high level, the disclosed software pipeline may involve a learning phase, where a fraud identification model is trained to identify new fraudulent applications. As described in greater detail below, the learning phase may involve: (i) obtaining information for processed applications, (ii) creating a knowledge graph to represent the information for the processed applications, (iii) transforming the knowledge graph, (iv) generating feature data for the processed applications, (v) identifying fraud rings within the knowledge graph, (vi) generating feature data for the identified fraud rings, and (vii) training the fraud identification model to identify new fraudulent applications, among other possibilities. Further, the knowledge graph that is created during the learning phase may be created in memory, and may further be kept in memory as it is transformed.

In some implementations, the fraud identification model may be trained to output predictions as to whether new applications are fraudulent, while in other implementations, the fraud identification model may instead be trained to output a set of rules that may be used to identify new fraudulent applications. As such, while much of the disclosure below describes the fraud identification model as outputting a set of rules for identifying new fraudulent applications, it should be understood that the fraud identification model may instead identify new fraudulent applications directly.

The learning phase is described in greater detail below.

Further, at a high level, the disclosed software pipeline may involve an evaluation phase, where the set of rules output by the fraud identification model (or the fraud identification model itself, as the case may be) is used in production to identify new fraudulent applications. As described in greater detail below, the evaluation phase may involve: (i) obtaining information for new applications, (ii) updating the knowledge graph to represent the information for the new applications, (iii) generating feature data for the new applications, (iv) generating updated feature data for the identified fraud rings, and (v) identifying new fraudulent applications, e.g., using the set of rules (or the fraud identification model, as previously described). The evaluation phase is described in greater detail below.

Further yet, in some implementations, the disclosed software pipeline may be encoded in Python and may be implemented in any computing environment that is capable of running Python. The disclosed software pipeline may take other forms as well, and may be implemented in various other programming languages.

The disclosed software pipeline improves upon existing technology for identifying fraudulent activity in various ways. First, the disclosed software pipeline is able to identify fraudulent activity at the account creation level using knowledge graphs, whereas existing technology is limited to using knowledge graphs to identify fraud at the transaction level. As explained above, identifying fraud at the account creation level may help stop fraudulent activity before financial losses are incurred, whereas identifying fraud at the transaction level often fails to prevent at least some amount of financial loss.

Second, the knowledge graph that is created and used by the disclosed software pipeline is stored in memory, whereas the knowledge graphs used in existing technology are stored in third-party graph databases. Storing the knowledge graph in memory offers various advantages. As one example, users are able to interact with the knowledge graphs stored in memory more dynamically than with knowledge graphs stored in third-party graph databases. For instance, users may interact with the memory-stored knowledge graphs using Python code, whereas the APIs used for interfacing with the knowledge graphs stored in third-party graph databases offer much more limited functionality. This may enable users of the disclosed software pipeline to perform various customized transformations on the knowledge graph in memory, e.g., using Python code, to discover more connections than originally shown in the knowledge graph.

Third, knowledge graphs stored in memory are easier to scale than knowledge graphs stored in third-party graph databases, and can utilize additional CPUs, parallel computing techniques, and clusters to scale the knowledge graph as the volume of application information represented in the knowledge graph increases, among other techniques to improve scaling that are not available to third-party graph databases. Further, knowledge graphs stored in memory can be scaled without the connectivity issues that plague existing technology utilizing third-party graph databases to store knowledge graphs.

The disclosed software pipeline improves upon existing technology for identifying fraudulent activity in other ways as well.

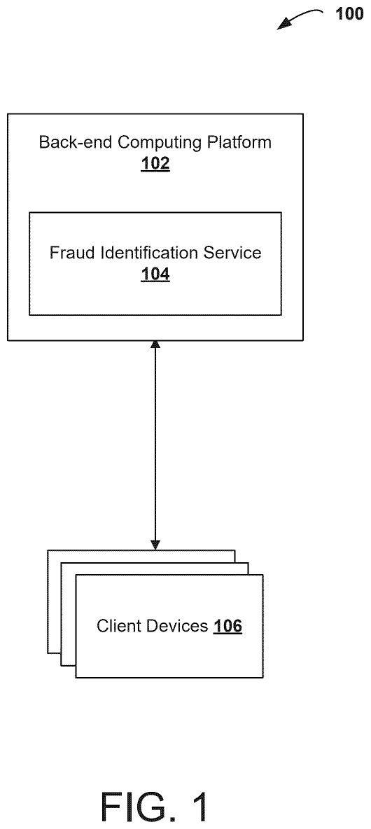

Turning now to the figures, FIG. 1 depicts an example network configuration 100 in which the disclosed software pipeline may be implemented. As shown in FIG. 1, the example network configuration 100 includes a back-end computing platform 102 and a plurality of client devices 106.

Broadly speaking, the back-end computing platform 102 may comprise one or more computing systems that collectively comprise some set of physical computing resources (e.g., one or more processors, one or more data stores, one or more communication interfaces, etc.) along with back-end software for carrying out the back-end functionality disclosed herein. As one possibility, the back-end computing platform 102 may comprise cloud computing resources supplied by a third-party provider of “on demand” cloud computing resources, such as Amazon Web Services (AWS), Amazon Lambda, Google Cloud, Microsoft Azure, or the like. As another possibility, the back-end computing platform 102 may comprise “on-premises” computing resources of the given software provider (e.g., servers owned by the given software provider). As yet another possibility, the back-end computing platform 102 may comprise a combination of cloud computing resources and on-premises computing resources. Other implementations of the back-end computing platform 102 are possible as well.

In accordance with the present disclosure, the back-end computing platform 102 may be provisioned with a functional component implemented in software that is configured to perform back-end functionality for utilizing knowledge graphs to identify fraudulent applications, in line with the disclosure above. This functional component may be referred to herein as the “fraud identification service” 104. Further, in line with the previous discussion, the disclosed software pipeline may be encoded in Python and may be implemented in any computing environment that is capable of running Python.

The back-end computing platform 102 may include various other functional components as well. Further, in practice, the functional components disclosed herein may be implemented using any of various software architecture styles, examples of which may include a microservices architecture, a service-oriented architecture, and/or a serverless architecture, among other possibilities, as well as any of various deployment patterns, examples of which may include a container-based deployment pattern, a virtual-machine-based deployment pattern, and/or a Lambda-function-based deployment pattern, among other possibilities.

Turning to the client devices 106, each client device 106 may generally take the form of any computing device that is capable of running client-side software for interacting with the back-end computing platform 102. In this respect, each client device 106 may include hardware components such as one or more processors, computer readable mediums, communication interfaces, and input/output (I/O) components (or interfaces for connecting thereto), among other possible hardware components, as well as software components such as operating system (OS) software, web browser software, and/or other client-side software for accessing and interacting with the back-end computing platform 102, among other possible software components. As representative examples, each client device 106 may take the form of a desktop computer, a laptop, a netbook, a tablet, a smartphone, or a personal digital assistant (PDA), among other possibilities.

As further depicted in FIG. 1, each client device 106 may be configured to communicate with the back-end computing platform 102 over a respective communication path. Each of these communication paths may generally comprise one or more data networks and/or data links, which may take any of various forms. For instance, each respective communication path between a client device 106 and the back-end computing platform 102 may include any one or more of a Personal Area Network (PAN), a Local Area Network (LAN), a Wide Area Networks (WAN) such as the Internet or a cellular network, a cloud network, and/or a point-to-point data link, among other possibilities, where each such data network and/or link may be wireless, wired, or some combination thereof, and may carry data according to any of various different communication protocols. Additionally, the communication between a client device 106 and the back-end computing platform 102 may be carried out via an Application Programming Interface (API) provided by the back-end computing platform 102, among other possibilities. Although not shown, the respective communication paths between the client devices 106 and the back-end computing platform 102 may also include one or more intermediate systems, examples of which may include a data aggregation system and host server, among other possibilities. Many other configurations are also possible.

It should be understood that the example network configuration 100 depicted in FIG. 1 is one example of a network configuration in which the disclosed software pipeline may be implemented. Numerous other arrangements are possible and contemplated herein. For instance, other network configurations may include additional components not pictured and/or more or fewer of the pictured components.

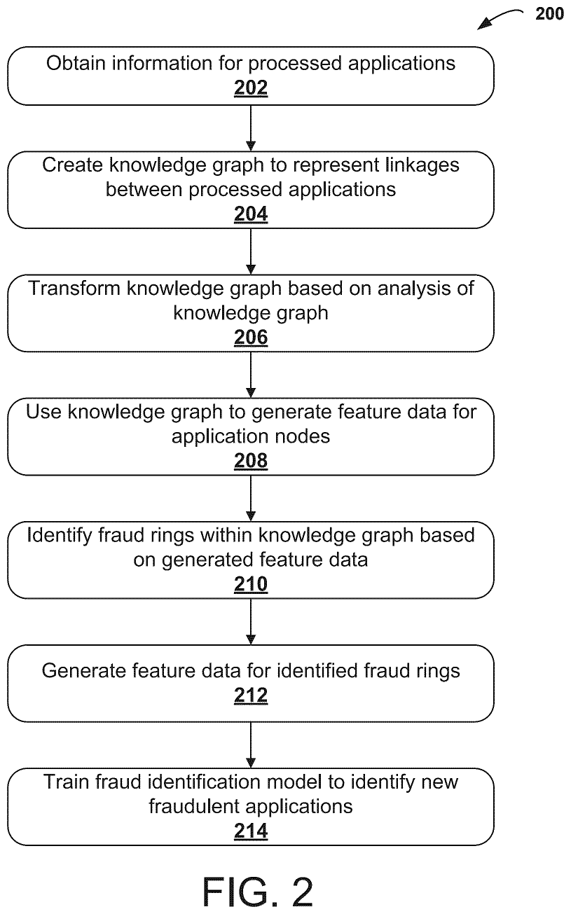

Turning now to FIG. 2, an example flow diagram of an example process 200 that may be carried out to perform the learning phase in accordance with the present disclosure is shown. For purposes of illustration only, the example process 200 is described as being carried out by the back-end computing platform 102 within the example network configuration 100 of FIG. 1. It should be understood, however, that this functionality may be carried out by any of various other devices in any of various other network configurations.

Starting at block 202, the back-end computing platform 102 may obtain information for applications that have previously been processed, e.g., by a financial institution. In line with the previous discussion, processing these applications may have involved deciding whether or not to create accounts based on the information included in the applications. The information that may be obtained for these processed applications may take various forms.

As one example, the information that may be obtained for a given processed application may include identification information related to the given processed application, which may include (i) identification information for an entity that submitted the processed application, such as a name, phone number, email address, SSN, and/or physical address associated with the entity and/or (ii) identification information for a client device used to submit the given processed application, such as a device ID and/or an IP address, among other possibilities. This type of identification information may be referred to herein as “attributes,” where one attribute may be a name, another attribute may be a phone number, another attribute may be an email address, and another attribute may be a SSN, etc.

As another example, the information that may be obtained for a given processed application may include decision information indicating whether the given processed application was approved or declined. Further, in some implementations, the decision information may further indicate a reason for why the given processed application was approved or declined, which may be useful in training the fraud identification model, as some declined applications may be indicative of fraud (e.g., an application that is declined for sharing the same SSN as another application that was previously submitted by a different entity) and other declined applications may not be indicative of fraud (e.g., an application that is declined for having too low of a credit score).

As yet another example, the information that may be obtained for a given processed application may include portfolio information for the entity that submitted the processed application, which may refer to the financial state of the entity and/or of one or more accounts owned by the entity. For instance, at the time an application is submitted, certain portfolio information for the entity may be available, such as a current credit score, a current balance in one or more accounts associated with the entity that submitted the application, etc. This portfolio information may be obtained for processed applications whether they were approved or declined. Further, in some implementations, additional portfolio information may be available for accounts created based on approved applications. Such additional portfolio information may include transaction history information, credit score history information, and/or credit repayment history information, among other possible types of portfolio information.

The back-end computing platform 102 may obtain various other kinds of information for processed applications as well.

Further, the back-end computing platform 102 may obtain the information for any number of processed applications. As one possibility, the back-end computing platform 102 may obtain the information for processed applications that were submitted to the financial institution within a given period of time, such as within the past day, week, month, quarter, or year, among other possible periods of time. As another possibility, the back-end computing platform 102 may obtain the information for all processed applications that were submitted to the financial institution. Further, in some implementations, the back-end computing platform 102 may be configured to exclude the information for certain applications, such as for applications that are known to be trustworthy, although in other implementations no such information may be excluded, as it may be beneficial for training the fraud identification model. The back-end computing platform 102 may obtain the information for any other number of processed applications as well.

Further yet, the back-end computing platform 102 may obtain the information for the processed applications from various sources. As one example, the back-end computing platform 102 may obtain the information from storage accessible to the back-end computing platform 102, whether internal or external to the back-end computing platform 102. For instance, the financial institution utilizing the back-end computing platform 102 may store submitted applications within storage accessible to the back-end computing platform 102, and, as the submitted applications are processed, the financial institution may also store an indication of the decision information for the processed applications. The financial institution may additionally store some portfolio information for created accounts, such as transaction history information, account balance information, and the like. In such implementations, the back-end computing platform 102 may be configured to obtain the information for those processed applications (and accounts created based on approved applications) from the storage.

As another example, the back-end computing platform 102 may obtain the information from a third party, such as a credit bureau. For instance, in some implementations, financial institutions may not store credit report information themselves, but instead may request such information from a credit bureau at various times, e.g., to make a decision for a submitted application. As such, in some implementations, the back-end computing platform 102 may be configured to obtain such information (e.g., a current credit score, credit score history information, etc.) from a third party such as a credit bureau.

As another example where the information may be obtained from a third party, in some implementations the back-end computing platform 102 may obtain information for applications that were not processed by the financial institution. For instance, a third party may provide information for applications processed by the third party to the back-end computing platform 102.

The back-end computing platform 102 may obtain the information for the processed applications from other sources as well.

At block 204, the back-end computing platform 102 may create a knowledge graph to represent linkages between the processed applications. In line with the previous discussion, the knowledge graph may be stored in memory.

These linkages may be direct (e.g., two processed applications that share at least one common attribute) or indirect (e.g., two processed applications that do not share any common attributes but that both share at least one common attribute with a third processed application), among other possibilities. As described in greater detail below, the various direct and indirect linkages between the processed applications may be used to generate feature data, to identify fraud rings, and to train the fraud identification model, among other possibilities.

The knowledge graph created by the back-end computing platform 102 may include one or more different types of nodes. One type of node that may be included in the knowledge graph may represent a processed application. This type of node will be referred to herein as an “application” node. In some implementations, the back-end computing platform 102 may further break application nodes down into “approved application” nodes that represent processed applications that were approved and “declined application” nodes that represent processed applications that were declined, e.g., based on decision information obtained for the processed applications. Application nodes may be broken down in other ways as well.

The knowledge graph created by the back-end computing platform 102 may also include a respective type of node for one or more attributes, which may be referred to herein as “attribute” nodes. For instance, the knowledge graph may include “name” attribute nodes, “phone number” attribute nodes, “SSN” attribute nodes, and/or “device ID” attribute nodes, among other possible attribute nodes. In some implementations, the back-end computing platform 102 may be configured to determine which types of attribute nodes to include in the knowledge graph. In practice, some attributes may be more useful in identifying fraudulent applications than others. For instance, two application nodes that share a common SSN may be more indicative of a fraud ring than two application nodes that share a common home address, among other examples. Accordingly, the back-end computing platform 102 may be configured to include attribute nodes to the knowledge graph that are more useful in identifying fraudulent applications. Similarly, the back-end computing platform 102 may be configured to exclude less useful types of attribute nodes from the knowledge graph, so as to avoid overwhelming the knowledge graph.

The back-end computing platform 102 may determine which types of attribute nodes to include in the knowledge graph in various ways. As one possibility, the back-end computing platform 102 may make this determination based on receiving an indication of a user selection of which attributes to create nodes for in the knowledge graph. For instance, an employee of the financial institution tasked with creating the knowledge graph may operate a client device 106 to select a set of attribute nodes, and the client device 106 may transmit an indication of the user selection to the back-end computing platform 102. As another possibility, the back-end computing platform 102 may make this determination based on an evaluation of the obtained information for the processed applications. For instance, the back-end computing platform 102 may determine which attributes referenced in the obtained information are most likely to be indicative of fraud rings, and may determine to include those types of attribute nodes in the knowledge graph. The back-end computing platform 102 may determine which types of attribute nodes to include in the knowledge graph in other ways as well.

The knowledge graph may include other types of nodes as well.

Further, the knowledge graph may also include edges to represent linkages between the nodes of the knowledge graph. There may be various types of edges between the nodes of the knowledge graph. For instance, one type of edge may represent the linkage between an application node and an attribute node, and this type of edge may be referred to herein as an “application-to-attribute” edge. In some implementations, application-to-attribute edges may be the only type of edge that is included when the knowledge graph is initially built. However, other types of edges may also be possible, either when the knowledge graph is initially built or after the knowledge graph has been transformed, as described below with respect to block 206.

In some implementations, the back-end computing platform 102 may determine weights for certain attributes. As previously mentioned, some attributes may be more indicative of fraud, such as SSN, and so the back-end computing platform 102 may determine a higher weight for those attributes than for other attributes that are less indicative of fraud. The back-end computing platform 102 may determine these weights in various ways. As one possibility, the back-end computing platform 102 may determine the weights for the attributes based on receiving an indication of user-specified weights for one or more attributes. For instance, an employee of the financial institution tasked with creating the knowledge graph may operate a client device 106 to provide input to specify weights for one or more attributes, and the client device 106 may transmit an indication of the user input to the back-end computing platform 102. As another possibility, the back-end computing platform 102 may make this determination based on an evaluation of the obtained information for the processed applications. For instance, the back-end computing platform 102 may determine which attributes referenced in the obtained information are most likely to be indicative of fraud rings, and may determine corresponding weights for the attributes. The back-end computing platform 102 may determine the weights for the attributes in other ways as well. The knowledge graph created by the back-end computing platform 102 may reflect the determined weights, as described in greater detail below.

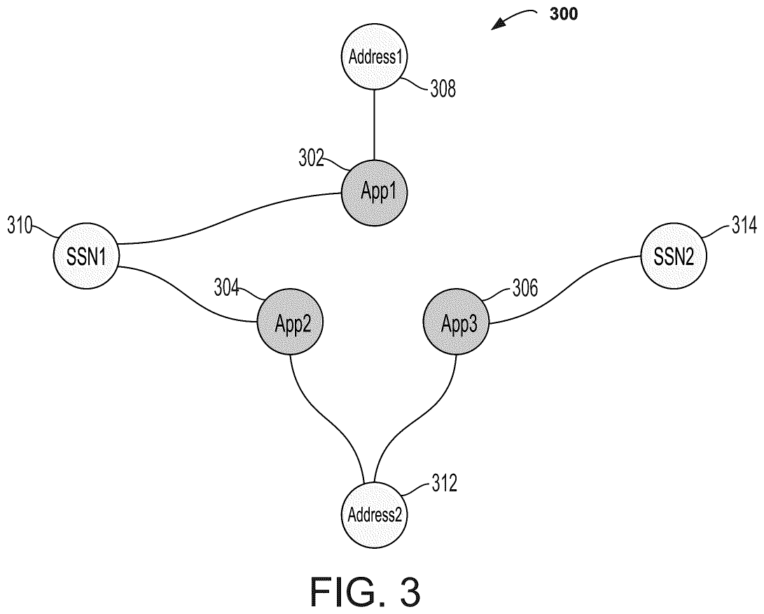

FIG. 3 depicts an example representation 300 of a knowledge graph that may be created by the back-end computing platform 102 in accordance with the present disclosure. For instance, in line with the previous discussion, the back-end computing platform 102 may obtain information for processed applications and create the knowledge graph based on the obtained information. In the example representation 300, the knowledge graph includes (i) a first application node 302, (ii) a second application node 304, and (iii) a third application node 306, each of which may be created by the back-end computing platform 102 based on obtained information for a respective processed application. However, it should be noted that knowledge graphs may be much larger than what is shown in FIG. 3, and may represent several thousand applications or more, depending on how many processed applications information is obtained for.

Further, in the example representation 300, the knowledge graph also includes (i) a first attribute node 308 for a first address, (ii) a second attribute node 310 for a first SSN, (iii) a third attribute node 312 for a second address, and (iv) a fourth attribute node 314 for a second SSN. In line with the previous discussion, the back-end computing platform 102 may have determined to include attribute nodes for addresses and SSNs, and then created the attribute nodes 308-314 to represent the different addresses and SSNs included in the obtained information for the processed applications.

Further yet, in the example representation 300, the knowledge graph includes various edges connecting the application nodes 302-306 to the attribute nodes 308-314. As shown, the first application node 302 is linked to the first attribute node 308 and the second attribute node 310, which indicates that the obtained information for the processed application represented by the first application node 302 included (i) the first address represented by the first attribute node 308 and (ii) the first SSN represented by the second attribute node 310. As further shown, the second application node 304 is linked to the second attribute node 310 and the third attribute node 312, which indicates that the obtained information for the processed application represented by the second application node 304 included (i) the first SSN represented by the second attribute node 310 and (ii) the second address represented by the third attribute node 312. As yet further shown, the third application node 306 is linked to the third attribute node 312 and the fourth attribute node 314, which indicates that the obtained information for the processed application represented by the third application node 306 included (i) the second address represented by the third attribute node 312 and (ii) the second SSN represented by the fourth attribute node 314.

As described in greater detail below, the linkages between the application nodes 302-306 and the attribute nodes 308-314 may be used to identify fraudulent activity. To illustrate with the example shown in FIG. 3, because the first and second applications represented by the application nodes 302 and 304 are both linked to the same SSN but to different addresses, it may be determined that the first and second applications may be part of a fraud ring. If either or both of the first and second applications are declined applications, that may be further indicative of a fraud ring. In contrast, the third application represented by the application node 306 may be less likely to be part of a fraud ring, because it does not share an SSN with any other application represented in the knowledge graph. Various other examples may also exist.

Returning to FIG. 2, at block 206, the back-end computing platform 102 may transform the knowledge graph based on an analysis of the knowledge graph. As with the creation of the knowledge graph, the knowledge graph may also be transformed directly in memory.

While the knowledge graph as originally created may provide useful information for identifying fraud rings, it may be desirable to transform the knowledge graph to have a different structure, which may reveal additional types of connections between the processed applications represented in the knowledge graph.

In practice, the back-end computing platform 102 may transform the knowledge graph in various ways. As one example, the back-end computing platform 102 may transform the knowledge graph by removing attribute nodes and application-to-attribute edges from the knowledge graph, and representing the information previously represented via those nodes and edges through edges between application nodes, which may be referred to herein as “application-to-application edges.” As another example, the back-end computing platform 102 may transform the knowledge graph by adding application-to-application edges without removing the attribute nodes and application-to-attribute edges from the knowledge graph. The back-end computing platform 102 may transform the knowledge graph in other ways as well.

To determine which application-to-application edges should be added to the knowledge graph, as well as what form the application-to-application edges should take, the back-end computing platform 102 may first perform an analysis of the knowledge graph to determine shared attributes between the application nodes in the knowledge graph. Then the back-end computing platform 102 may add application-to-application edges between the application nodes in the knowledge graph to represent the aggregation of shared attributes between the application nodes.

The application-to-application edges may take various forms. As one example, an application-to-application edge may include an indication of the number of shared attributes between linked application nodes. As another example, an application-to-application edge may include an indication of which attributes are shared between linked application nodes. As yet another example, an application-to-application edge may include an indication of the weights of the shared attributes between linked application nodes. Various other examples may also exist.

In practice, the back-end computing platform 102 may transform the knowledge graph at various times during the learning phase. As one possibility, the back-end computing platform 102 may transform the knowledge graph as part of the process for creating the knowledge graph in the first place, in which case the operations of block 206 may be incorporated into block 204. As another possibility, the back-end computing platform 102 may transform the knowledge graph as part of training the fraud identification model as described below with respect to block 214. The back-end computing platform 102 may transform the knowledge graph at other times as well. As such, it should be understood that reference to a knowledge graph below with respect to the discussion of the learning phase may refer to either a knowledge graph as originally created, without transformation, or to a knowledge graph that has been transformed into a different structure.

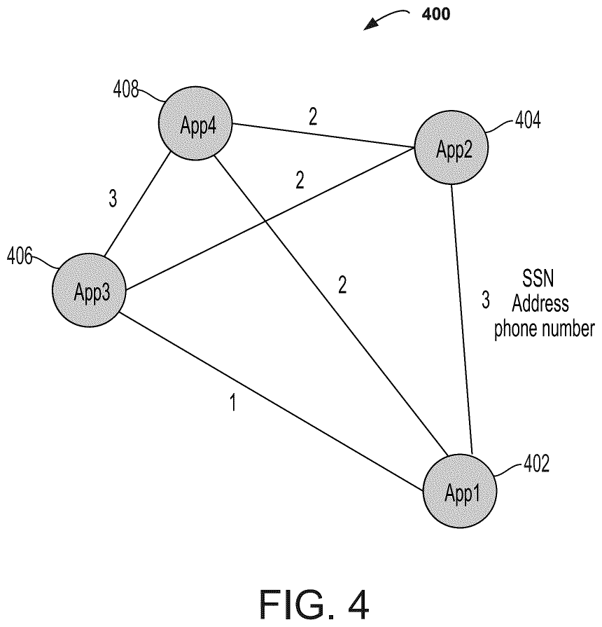

Turning now to FIG. 4, an example representation 400 of a transformed knowledge graph that may be created by the back-end computing platform 102 in accordance with the present disclosure is shown.

As shown, the example representation 400 of the transformed knowledge graph includes four application nodes: a first application node 402, a second application node 404, a third application node 406, and a fourth application node 408. Further, as shown, each of the application nodes 402-408 is linked to every other application node via a respective application-to-application edge. This may indicate that all four of the application nodes 402-408 share at least one respective attribute in common with each of the other application nodes shown in FIG. 4, although the shared attributes between the application nodes are not necessarily the same as each other. As shown, the edges between the application nodes 402-408 include a number, which in the example shown in FIG. 4 may indicate a number of shared attributes between the application nodes. For instance, the first application node 402 is shown sharing three attributes with the second application node 404, one attribute with the third application node 406, and two attributes with the fourth application node 408. Further, the second application node 404 is shown sharing two attributes with the third application node 406 and two attributes with the fourth application node 408. Further yet, the third application node 406 is shown sharing three attributes with the fourth application node 408. The three shared attributes between the first application node 402 and the second application node 404 are shown to include a shared SSN, a shared address, and a shared phone number, and although not shown, the other shared attributes between the other application nodes may also include indications of which attributes are shared between the application nodes, in line with the previous discussion. Other examples may also exist.

In line with the previous discussion, the knowledge graph created by the back-end computing platform 102 may be used to train the fraud identification model to output rules for identifying new fraudulent applications (e.g., new applications that are linked to identified fraud rings). However, the knowledge graph alone may be insufficient to train the fraud identification model. To resolve this issue, the back-end computing platform 102 may be configured to generate feature data for the processed applications represented in the knowledge graph, and to then use the generated feature data to train the fraud identification model.

Returning again to FIG. 2, at block 208, the back-end computing platform 102 may use the knowledge graph to generate feature data for application nodes within the knowledge graph. For simplicity, the operations of block 208 are described within the context of a knowledge graph that includes application nodes and application-to-application edges, however, the operations of block 208 may similarly be applied to knowledge graphs that include attribute nodes and application-to-attribute edges as well.

The back-end computing platform 102 may generate feature data for application nodes in various ways.

As one possibility, the back-end computing platform 102 may generate feature data for application nodes based on an analysis of the linkages between application nodes within the knowledge graph. This analysis may include determining how many attributes are shared between application nodes, determining weights of said shared attributes, determining clusters of application nodes that share similar attributes (either through direct linkage or indirect linkage), evaluating graph paths between various application nodes, etc. Further, in some implementations, the analysis may also be based on the decision information obtained by the back-end computing platform 102 for the processed applications represented in the knowledge graph. For instance, the analysis may involve determining whether the processed applications were approved or declined when they were processed, as being linked with a declined application may, in some instances, be more indicative of fraud than being linked with an approved application. The analysis may take other forms as well.

By analyzing the linkages between the application nodes within the knowledge graph, the back-end computing platform 102 may be able to determine certain feature data that indicates the strength of a linkage between applications nodes. In line with the discussion above, such feature data may be generated based on how many attributes the application nodes share, the respective weights of the shared attributes, whether the application nodes are directly or indirectly linked, and, if indirectly linked, what path through the knowledge graph connects the application (e.g., the shortest path), among other things. Some examples of feature data that may be generated for a given application node based on an analysis of the linkages between the given application node and other application nodes in the knowledge graph may include: (i) the number of direct linkages the given application node shares with other application nodes, (ii) the total count of application nodes that share a common attribute with the given application node (e.g., either via a direct or indirect linkage), (iii) the weighted strength of linkages between the given application node and other application nodes in the knowledge graph, (iv) the total count of application nodes that share one or more attributes with the given application node but that have other combinations of different attributes (e.g., same SSN but different phone number, same SSN but different device ID, etc.), (v) the shortest path between the given application and other applications (e.g., based on direct and indirect linkages), which may be weighted or unweighted, and (vi) the percentage of the given application's linkages that are linked with declined applications, among various other examples.

As another possibility, the back-end computing platform 102 may generate feature data for application nodes based, at least in part, on the portfolio information obtained for the processed applications represented in the knowledge graph. As previously mentioned, accounts may be created for approved applications, and the back-end computing platform 102 may obtain portfolio information for the created accounts. The back-end computing platform 102 may generate feature data that reflects the portfolio information obtained for those created accounts, which may provide useful insights into those applications that may be indicative of fraudulent activity, such as whether credit limits were exceeded and/or whether credit balances were repaid, among other examples. Further, as previously discussed, some portfolio information may also be obtained for declined applications, and the back-end computing platform 102 may also generate some feature data based on that portfolio information. Further yet, in some implementations, in may be possible to obtain profile information for other accounts created by the same entity, such as other credit accounts, checking accounts, savings accounts, etc. that have been created by the entity. Other examples may also exist.

As yet another possibility, the back-end computing platform 102 may generate feature data for application nodes based on receiving an indication of user input indicating which types of feature data to generate. For instance, an employee of the financial institution tasked with performing feature engineering for the knowledge graph may operate a client device 106 to provide input to specify certain feature data that is to be generated for the application nodes, and the client device 106 may transmit an indication of the user input to the back-end computing platform 102.

The back-end computing platform 102 may generate feature data for application nodes in various other ways as well.

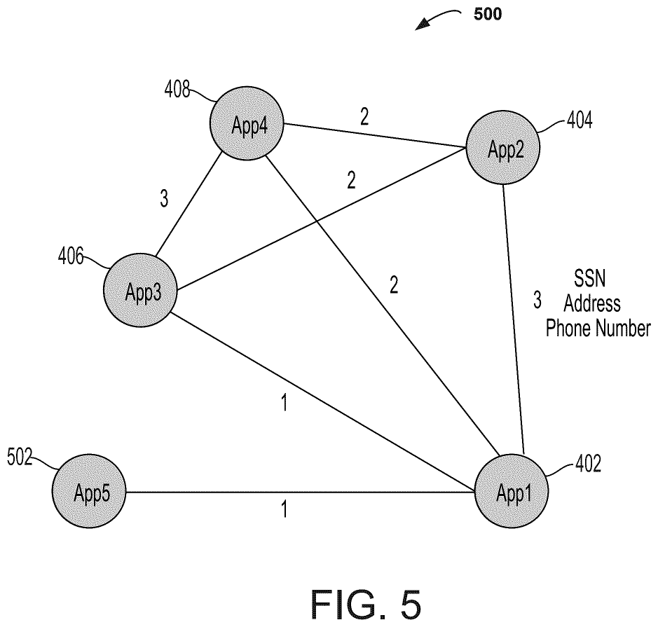

Some examples of how the knowledge graph may be used to generate feature data will now be described with reference to FIG. 5. As shown, FIG. 5 depicts an example representation 500 of a knowledge graph, which may be similar to the example representation 400 of FIG. 4 but with the inclusion of a fifth application node 502 that shares a single attribute in common with the first application node 402, and that does not share any attributes in common with the other application nodes 404-408. In line with the previous discussion, one example type of feature data that the back-end computing platform 102 may be configured to determine may be the shortest path between two application nodes. Using the fifth application node 502 and the second application node 404 as an example, the shortest path may be an indirect linkage that goes from the fifth application node 502 to the first application node 402 and then to the second application node 404. Further, in line with the previous discussion, another example type of feature data that the back-end computing platform 102 may be configured to determine may be a shortest path between two application nodes that is weighted according to the number of attributes that are shared between application nodes. The shortest path may be weighted by dividing the steps between the application nodes by the amount of attributes that the application nodes share at each step. As may be appreciated, this may result in more strongly weighted paths having a smaller numerical value. The shortest path may be weighted in other ways as well.

The fifth application node 502 and the second application node 404 will be used again as an example of how a weighted shortest path may be determined between two application nodes. In the example shown in shown in FIG. 5, the weighted linkage between the fifth application node 502 and the first application node 402 may be 1 (e.g., 1 step divided by 1 shared attribute). Further, in the example shown in FIG. 5, the weighted linkage between the first application node 402 and the second application node 404 may be 1/3 (e.g., 1 step divided by 3 shared attributes). Adding these together, the weighted linkage between the fifth application node 502 and the second application node 404 may be 4/3 (e.g., 1 plus 1/3). As may be appreciated, various other weighted shortest paths may also be determined using the knowledge graph.

As previously mentioned, the back-end computing platform 102 may generate feature data in various other manners as well.

Returning to FIG. 2, at block 210, the back-end computing platform 102 may identify one or more fraud rings within the knowledge graph based on the generated feature data for application nodes. In line with the previous discussion, a fraud ring may include a group of individuals or organizations that work together to commit fraud. At the account application stage, this may include submitting applications to open credit accounts using false information. One method that fraud rings deploy to avoid detection is to test different combinations of identification information to try to obtain an approval to open a credit account. By linking the processed applications into a knowledge graph, the back-end computing platform 102 may be able to reveal patterns that are indicative of fraud rings within the knowledge graph. For instance, a cluster of declined applications that share at least one common attribute may be indicative of a fraud ring. Various other patterns may be indicative of fraud rings, and the back-end computing platform 102 may be configured to detect such patterns based on an analysis of the knowledge graph along with the feature data generated for the application nodes of the knowledge graph. After identifying the one or more fraud rings within the knowledge graph, the back-end computing platform 102 may generate and store a respective fraud ring ID for each of the identified fraud rings.

At block 212, the back-end computing platform 102 may use the knowledge graph to generate feature data for the identified fraud rings. As with the feature data generated for the application nodes, the feature data generated for the identified fraud rings may also be used to train the fraud identification model, as described in greater detail below. Further, for simplicity, the operations of block 212 are described within the context of a knowledge graph that includes application nodes and application-to-application edges, however, the operations of block 212 may similarly be applied to knowledge graphs that include attribute nodes and application-to-attribute edges as well.

The back-end computing platform 102 may generate feature data for the identified fraud rings in various ways. As with the feature data generated for the application nodes, the back-end computing platform 102 may similarly generate feature data for the identified fraud rings based on an analysis of the linkages between application nodes within each identified fraud ring. The types of feature data that may be generated in this way for each identified fraud ring may be similar to those previously described, with the exception that they may be generated based on analysis of the application nodes that are within the identified fraud ring, allowing for more targeted feature data to be generated.

Similarly, as before, the back-end computing platform 102 may also generate feature data for each identified fraud ring based on the profile information obtained for the processed applications within the identified fraud ring. The types of feature data generated in this way for each identified fraud ring may also be similar to those previously described, with the exception that because the application nodes within the identified fraud ring are known to be connected, further feature data may be generated based on the combination of profile information obtained for the application nodes within the identified fraud ring.

Similarly, as before, the back-end computing platform 102 may also generate feature data for each identified fraud ring based on receiving an indication of user input indicating which types of feature data to generate for the identified fraud ring. Other possibilities may also exist.

As mentioned above, in addition to the types of feature data that may be generated for identified fraud rings that are similar to those generate for application nodes in general, various other types of fraud ring-specific feature data may be generated.

One possible type of fraud ring-specific feature data that may be generated for a given identified fraud ring may include feature data determined based on patterns of various combinations of shared attributes between application nodes within the given identified fraud ring. Theses patterns may take various forms, and one type of pattern that may be analyzed for generating feature data may include determining discrepancies between combinations of shared attributes amongst application nodes within a given identified fraud ring. For instance, feature data may be generated to capture, for application nodes within the given identified fraud ring that share a first attribute in common, an amount of those application nodes that do not share a second attribute in common. To illustrate with an example, the feature data may be generated to capture the amount of application nodes that share a same phone number but that have a different SSN.

Another type of pattern may include determining timing patterns for application nodes sharing a common attribute. For instance, feature data may be generated to capture timing patterns for how often processed applications represented in the application nodes within the given identified fraud ring are submitted using the same SSN. As may be appreciated, various other patterns may also exist, such as patterns based on counts and/or ratios of declined applications to approved applications with the given identified fraud ring, among other examples.

Another possible type of fraud ring-specific feature data that may be generated for a given identified fraud ring may include feature data determined based on the profile information for the application nodes within the given identified fraud ring. For instance, profile information for the accounts that have been created based on approved applications represented within the given identified fraud ring, as well as for other accounts linked to those created accounts (e.g., opened by the same entity) may be aggregated to identify characteristics of the given identified fraud ring. As one example, patterns such as quickly running up credit on credit accounts before moving to do the same on new credit accounts may be characteristic of fraud rings, and feature data for the given identified fraud ring may be generated based on such patterns. Various other examples and patterns may also exist within the profile information for which feature data may be generated for the given identified fraud ring.

Other types of fraud ring-specific feature data may also be generated.

At block 214, the back-end computing platform 102 may train the fraud identification model to identify new fraudulent applications. In line with the previous discussion, the fraud identification model, once it is trained, may be configured to receive information for new applications and, using the knowledge graph and generated feature data, among other things, output either (i) a prediction as to whether the new application is fraudulent or (ii) a set of rules that may be used to identify new fraudulent applications.

To accomplish this, the back-end computing platform 102 may provide input data to one or more model training techniques, which may be applied to the training data to train the fraud identification model. The one or more model training techniques may take any of various forms, some examples of which may include boosting algorithm techniques (such as through the use of decision tree algorithms among other possible boosting algorithms), a neural network technique (which is sometimes referred to as “deep learning”), a regression technique, a k-Nearest Neighbor (kNN) technique, a decision-tree technique, a support vector machines (SVM) technique, a Bayesian technique, an ensemble technique, a clustering technique, an association-rule-learning technique, a dimensionality reduction technique, an optimization technique such as gradient descent, a regularization technique, and/or a reinforcement technique, among other possible types of model training techniques.

The input data provided to the one or more model training techniques may take various forms. As one example, the input data may include the knowledge graph created (or transformed) by the back-end computing platform 102. As another example, the input data may include any of the obtained information at block 202, from which the knowledge graph was created. This may ensure that the knowledge graph has access to information that was used to create the knowledge graph, but which may not be included in the knowledge graph itself, e.g., such as attributes that were not determined to be included in the knowledge graph, in line with the previous discussion. As yet another example, the input data may include any of the feature data generated by the back-end computing platform 102, e.g., for the application nodes in the knowledge graph and/or for the identified fraud rings in the knowledge graph. As yet still another example, the input data may include the fraud ring IDs generated by the back-end computing platform 102, which may be used to identify which application nodes are included in each identified fraud ring. As yet another example, the input data may include ground truth data, which may include indications of known fraud rings and/or indications of application nodes representing processed applications that are known to be submitted with false information, among other possible types of ground truth data that may be used to train the fraud identification model. The input data may take other forms as well.

After training the fraud identification model, the back-end computing platform 102 may then evaluate and validate the performance of the fraud identification model. This evaluation and validation may take various forms. As previously mentioned, in some implementations, the fraud identification model may be configured to output a set of rules for identifying fraudulent applications. In such implementations, the fraud identification model may analyze the knowledge graph, feature data, etc. to determine and then output a set of rules that predicts whether a new application is likely to be involved in an identified fraud ring. Then, the back-end computing platform 102 may evaluate and validate the set of rules output by the fraud identification model to determine the rules'accuracy in identifying new fraudulent applications, e.g., by measuring the rules'accuracy in correctly identifying known fraudulent applications. Further, the back-end computing platform 102 may evaluate the set of rules to determine whether the number of false positives is low enough to satisfy performance standards. The back-end computing platform 102 may evaluate and validate the set of rules in other ways as well to determine whether the learning phase is completed.

Alternatively, as previously mentioned, in some implementations the fraud identification model may be configured to identify fraudulent applications directly. In such implementations, the back-end computing platform 102 may evaluate and validate the fraud identification model to determine the fraud identification model's accuracy in identifying new fraudulent applications, which the back-end computing platform 102 may accomplish in a manner similar to the discussion above.

If the fraud identification model needs to be updated, e.g., to adjust the set of rules output by the fraud identification model or to adjust the identification operations of the fraud identification model itself, then the back-end computing platform 102 may update the input data and evaluate and validate the fraud identification model and/or the set of rules again.

The back-end computing platform 102 may update the input data in various ways. As one example, the back-end computing platform 102 may transform the knowledge graph in one or more ways to generate different structures and reveal different kinds of linkages between application nodes. As another example, the back-end computing platform 102 may determine different attributes to be represented within the knowledge graph. As yet another example, the back-end computing platform 102 may determine different weights to apply to the attributes. As yet another example, the back-end computing platform 102 may update the feature data that is generated for the application nodes and/or for the identified fraud rings, e.g., based on the transformed knowledge graph, the updated weights, etc. As yet another example, the back-end computing platform 102 may update the identified fraud rings, e.g., based on the transformed knowledge graph, the updated weights, the updated feature data, etc. The back-end computing platform 102 may update the input data in other ways as well.

Further, in some implementations, the fraud identification model may be used to determine how to update the input data. For instance, the fraud identification model may be configured to output, in addition to the set of rules, an indication of the importance of various types of feature data in identifying fraudulent applications. The back-end computing platform 102 may use this indication to determine how to update the input data. Other possibilities may also exist.

The back-end computing platform 102 may continue to evaluate and validate the performance of the fraud identification model and update the input data as needed until the performance of the fraud identification model is within acceptable performance standards.

The fraud identification model may be trained in other ways as well, including based on any type of supervised, unsupervised, semi-supervised, and/or self-supervised learning techniques.

Once the learning phase is completed, the knowledge graph, features data, fraud ring IDs, the fraud identification model, and/or the set of rules may be stored in memory for use during production.

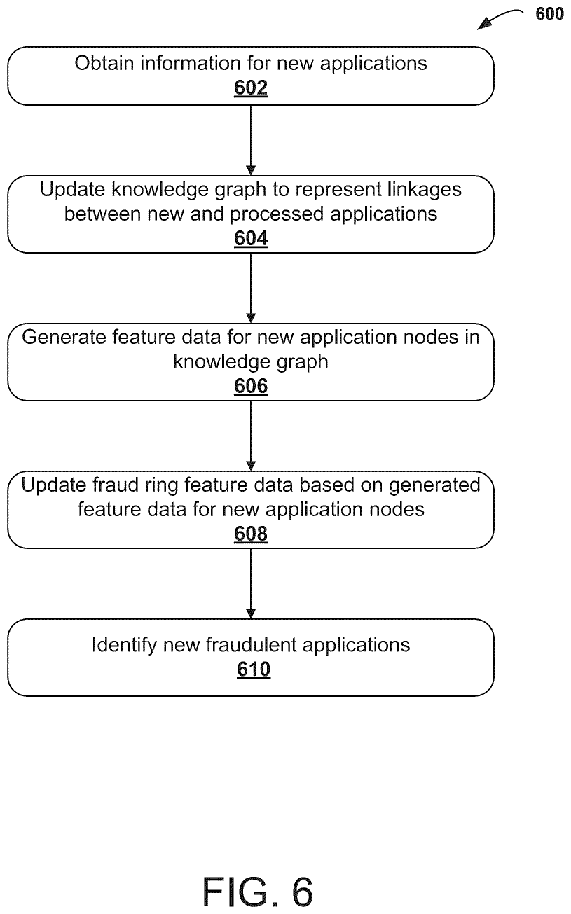

Turning now to FIG. 6, an example flow diagram of an example process 600 that may be carried out to perform the evaluation phase in accordance with the present disclosure is shown. For purposes of illustration only, the example process 600 is described as being carried out by the back-end computing platform 102 within the example network configuration 100 of FIG. 1. It should be understood, however, that this functionality may be carried out by any of various other devices in any of various other network configurations.

Starting at block 602, the back-end computing platform 102 may obtain information for new applications received by a financial institution. The information that may be obtained for the new applications may be, in many aspects, similar to the information obtained for the processed applications as described with respect to block 202. However, unlike the processed applications, the new applications may not yet have any decision information. As such, the information that may be obtained for the new applications may include attribute information and/or portfolio information, among other possible examples.

Further, the back-end computing platform 102 may obtain the information for new applications at various times. As one possibility, the back-end computing platform 102 may obtain the information for new applications as they are submitted. As another possibility, the back-end computing platform 102 may obtain the information for new applications in batches, e.g., on a daily or weekly basis, among other possible time periods. The back-end computing platform 102 may obtain the information for new applications at other times as well.

Further yet, the back-end computing platform 102 may obtain the information for the processed applications from various sources. As one example, the back-end computing platform 102 may obtain the information from storage accessible to the back-end computing platform 102, whether internal or external to the back-end computing platform 102. For instance, the financial institution utilizing the back-end computing platform 102 to identify new fraudulent applications may store submitted applications within storage accessible to the back-end computing platform 102. In such implementations, the back-end computing platform 102 may be configured to obtain the information for those submitted applications from the storage.

As another example, the back-end computing platform 102 may obtain the information from a third party, such as a credit bureau. For instance, in some implementations, financial institutions may not store credit report information themselves, but instead may request such information from a credit bureau at various times, e.g., to make a decision for a submitted application. As such, in some implementations, the back-end computing platform 102 may be configured to obtain such information (e.g., a current credit score, credit score history information, etc.) from a third party such as a credit bureau.

The back-end computing platform 102 may obtain the information for the new applications from other sources as well.

At block 604, the back-end computing platform 102 may update the knowledge graph to represent the linkages between the new applications and the processed applications included in the knowledge graph. This may involve adding new application nodes to the knowledge graph to represent the new applications, as well as adding new edges between the new application nodes and the existing nodes within the knowledge graph. In line with the previous discussion, the knowledge graph may include processed application nodes and possibly attribute nodes, and the back-end computing platform 102 may add application-to-application edges and possible application-to-attribute edges to the knowledge graph to link the new applications to the other nodes within the knowledge graph.

In some implementations, the back-end computing platform 102 may also transform the knowledge graph based on an analysis of the knowledge graph including the newly added application nodes and edges, which the back-end computing platform 102 may do in a manner similar to that previously described with respect to block 206.

At block 606, the back-end computing platform 102 may use the updated knowledge graph to generate feature data for new application nodes within the knowledge graph. The feature data that may be generated for the new application nodes may be established based on the learning phase. For instance, after the learning phase has completed, the back-end computing platform 102 may have stored all of the different types of feature data that has been generated for the processed application nodes. These may define the types of feature data that may be generated for the new application nodes, which the back-end computing platform 102 may generate in a manner similar to that previously described with respect to block 208. Other possibilities may also exist.

At block 608, the back-end computing platform 102 may update the feature data for the identified fraud rings, e.g., based on the feature data generated for the new application nodes. In practice, the back-end computing platform 102 may update the fraud ring-specific feature data for identified fraud rings based on patterns of various combinations of shared attributes between the application nodes of the identified fraud rings and the new application nodes. These patterns may take various forms, including the examples previously described with respect to block 212. Further, the back-end computing platform 102 may update the fraud ring-specific feature data for identified fraud rings based on any profile information that may be available for new application nodes that are linked in some way to identified fraud rings.

Further, in some implementations, the back-end computing platform 102 may update the identified fraud rings to include new application nodes that are determined to be included in the identified fraud rings. In practice, this may be part of a retraining process, as described in greater detail below.

At block 610, the back-end computing platform 102 may identify new fraudulent applications, e.g., using the set of rules output during the learning phase. To accomplish this, the back-end computing platform 102 may provide input data to the set of rules, which may take various forms. For instance, the input data may include data such as (i) the updated knowledge graph, (ii) the feature data generated for the new application nodes, and (iii) the updated feature data for the identified fraud rings to the set of rules, among other things, e.g., such as features data for the processed application nodes in the knowledge graph.

After inputting the input data to the set of rules, the set of rules may then output a prediction as to whether a new application is fraudulent or not, e.g., based on the new application being connected to an identified fraud ring, among other possibilities. In practice, the set of rules may make the fraud determination on an application-by-application basis. For instance, while the knowledge graph may be updated based on a batch of new applications, the set of rules may be run for each new application. As another possibility, the set of rules may make the fraud determination for the batch of new applications together.

In practice, the back-end computing platform 102 may perform the evaluation phase at various times. In line with the previous discussion, information for new applications may be obtained in batches, e.g., on a daily basis, weekly basis, or according to some other schedule. In such implementations, the rest of the operations of the evaluation phase may also be performed according to the schedule. For instance, if information for new applications are obtained on a daily basis, then the operations of the evaluation phase may be performed on a daily basis as well.

In some implementations, the knowledge graph may be reset after each execution of the evaluation phase, so that each new batch of applications may be used to update the knowledge graph as it was saved in memory at the time the learning phase was completed. In other implementations, however, the updates to the knowledge graph may be retained for a period of time. For instance, the knowledge graph may be updated with each new batch of applications, and may only reset periodically, e.g., every month. Other possibilities may also exist.

After completing the evaluation phase, the back-end computing platform 102 may then be configured to perform one or more additional operations. For instance, as one possibility, the back-end computing platform 102 may be configured to automatically approve or decline new applications based on the output of the set of rules. As another possibility, the back-end computing platform 102 may be configured to provide a notification of the output of the set of rules for new applications, e.g., to assist in the decision process for the new applications.

As yet another possibility, in some implementations, the back-end computing platform 102 may be configured to retrain the fraud identification model at various times. As new applications are added to the knowledge graph, new linkages may be made between application nodes of the knowledge graph, and new fraud rings may be identified over time, and it may be valuable for the fraud identification model to be retrained to account for these new developments. Accordingly, in some implementations, some or all of the learning phase may be repeated, and the information for the new applications may be added to the information that is obtained at block 202. Further, although the disclosed software pipeline has been described in the context of identifying fraud based on information for credit account applications, in some implementations, the principles described herein may be applicable in other contexts as well. As one example, it may be possible to use the disclosed software pipeline to identify fraud based on other types of financial activity, in addition to or possibly instead of credit account applications. For instance, the disclosed software pipeline may be used to create and/or update a knowledge graph to represent information for deposits, withdraws, and/or wire transfers, among other possible types of financial activity. This information may be represented in various types of nodes, such as “deposit” nodes, “withdraw” nodes, and/or “wire transfer” nodes, among other possibilities. Further, attributes for these types of financial activity, including respective weights for the attributes, may also be represented in the knowledge graph, e.g., in instances where such attributes differ from those previously described. Linkages between these nodes (and possibly between application nodes and/or attribute nodes) may also be created, such as in the manner previously described. By representing these different types of financial activity, the knowledge graph may be able to highlight further insights that may be useful in identifying fraud.

As another example, it may be possible to use the disclosed software pipeline for purposes other than for identifying fraud. For instance, it may be possible to use the disclosed software pipeline to identify linked applications that are not fraudulent, e.g., to help ad campaigns to provide more relevant advertisements to similarly situated applicants. Other possibilities may also exist.

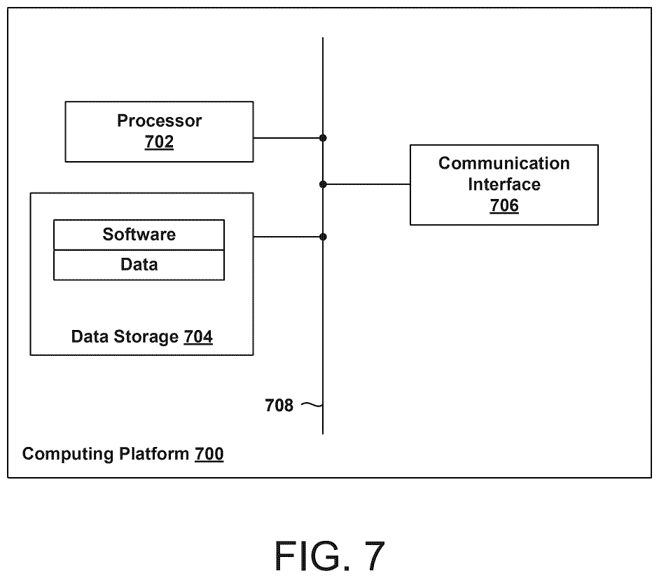

Turning now to FIG. 7, a simplified block diagram is provided to illustrate some structural components that may be included in an example computing platform 700 that may be configured to perform the server-side functions disclosed herein. At a high level, the example computing platform 700 may generally comprise any one or more computer systems (e.g., one or more servers) that collectively include one or more processors 702, data storage 704, and one or more communication interfaces 706, each of which may be communicatively linked by a communication link 708 that may take the form of a system bus, a communication network such as a public, private, or hybrid cloud, or some other connection mechanism. Each of these components may take various forms.

For instance, the one or more processors 702 may comprise one or more processor components, such as one or more central processing units (CPUs), graphics processing units (GPUs), application-specific integrated circuits (ASICs), digital signal processor (DSPs), and/or programmable logic devices such as field programmable gate arrays (FPGAs), among other possible types of processing components. In line with the discussion above, it should also be understood that the one or more processors 702 could comprise processing components that are distributed across a plurality of physical computing devices connected via a network, such as a computing cluster of a public, private, or hybrid cloud.

In turn, the data storage 704 may comprise one or more non-transitory computer-readable storage mediums, examples of which may include volatile storage mediums such as random-access memory, registers, cache, etc. and non-volatile storage mediums such as read-only memory, a hard-disk drive, a solid-state drive, flash memory, an optical-storage device, etc. In line with the discussion above, it should also be understood that the data storage 704 may comprise computer-readable storage mediums that are distributed across a plurality of physical computing devices connected via a network, such as a storage cluster of a public, private, or hybrid cloud that operates according to technologies such as AWS for Elastic Compute Cloud, Simple Storage Service, etc.

As shown in FIG. 7, the data storage 704 may be capable of storing both (i) program instructions that are executable by the one or more processors 702 such that the example computing platform 700 is configured to perform any of the various functions disclosed herein (including but not limited to any of the server-side functions discussed above), and (ii) data that may be received, derived, or otherwise stored by the example computing platform 700.

The one or more communication interfaces 706 may comprise one or more interfaces that facilitate communication between the example computing platform 700 and other systems or devices, where each such interface may be wired and/or wireless and may communicate according to any of various communication protocols. As examples, the one or more communication interfaces 706 may take include an Ethernet interface, a serial bus interface (e.g., Firewire, USB 3.0, etc.), a chipset and antenna adapted to facilitate any of various types of wireless communication (e.g., Wi-Fi communication, cellular communication, Bluetooth® communication, etc.), and/or any other interface that provides for wireless or wired communication. Other configurations are possible as well.

Although not shown, the example computing platform 700 may additionally have an Input/Output (I/O) interface that includes or provides connectivity to I/O components that facilitate user interaction with the example computing platform 700, such as a keyboard, a mouse, a trackpad, a display screen, a touch-sensitive interface, a stylus, a virtual-reality headset, and/or one or more speaker components, among other possibilities.

It should be understood that the example computing platform 700 is one example of a computing platform that may be used with the examples described herein. Numerous other arrangements are possible and contemplated herein. For instance, in other examples, the example computing platform 700 may include additional components not pictured and/or more or less of the pictured components.

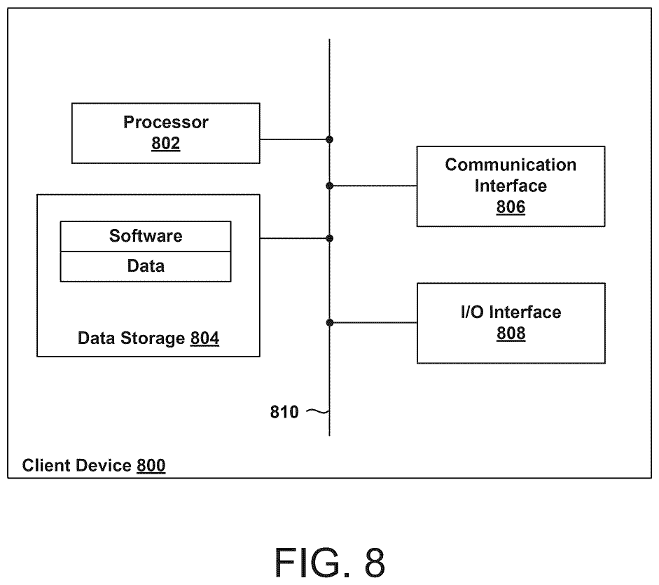

Turning next to FIG. 8, a simplified block diagram is provided to illustrate some structural components that may be included in an example client device 800 that may be configured to perform some the client-side functions disclosed herein. At a high level, the example client device 800 may include one or more processors 802, data storage 804, one or more communication interfaces 806, and an I/O interface 808, each of which may be communicatively linked by a communication link 810 that may take the form a system bus and/or some other connection mechanism. Each of these components may take various forms.

For instance, the one or more processors 802 of the example client device 800 may comprise one or more processor components, such as one or more CPUs, GPUs, ASICs, DSPs, and/or programmable logic devices such as FPGAs, among other possible types of processing components.

In turn, the data storage 804 of the example client device 800 may comprise one or more non-transitory computer-readable mediums, examples of which may include volatile storage mediums such as random-access memory, registers, cache, etc. and non-volatile storage mediums such as read-only memory, a hard-disk drive, a solid-state drive, flash memory, an optical-storage device, etc. As shown in FIG. 8, the data storage 804 may be capable of storing both (i) program instructions that are executable by the one or more processors 802 of the example client device 800 such that the example client device 800 is configured to perform any of the various functions disclosed herein (including but not limited to any of the client-side functions discussed above), and (ii) data that may be received, derived, or otherwise stored by the example client device 800.

The one or more communication interfaces 806 may comprise one or more interfaces that facilitate communication between the example client device 800 and other systems or devices, where each such interface may be wired and/or wireless and may communicate according to any of various communication protocols. As examples, the one or more communication interfaces 806 may take include an Ethernet interface, a serial bus interface (e.g., Firewire, USB 3.0, etc.), a chipset and antenna adapted to facilitate any of various types of wireless communication (e.g., Wi-Fi communication, cellular communication, Bluetooth® communication, etc.), and/or any other interface that provides for wireless or wired communication. Other configurations are possible as well.

The I/O interface 808 may generally take the form of (i) one or more input interfaces that are configured to receive and/or capture information at the example client device 800 and (ii) one or more output interfaces that are configured to output information from the example client device 800 (e.g., for presentation to a user). In this respect, the one or more input interfaces of I/O interface may include or provide connectivity to input components such as a microphone, a camera, a keyboard, a mouse, a trackpad, a touchscreen, and/or a stylus, among other possibilities, and the one or more output interfaces of the I/O interface 808 may include or provide connectivity to output components such as a display screen and/or an audio speaker, among other possibilities.

It should be understood that the example client device 800 is one example of a client device that may be used with the examples described herein. Numerous other arrangements are possible and contemplated herein. For instance, in other examples, the example client device 800 may include additional components not pictured and/or more or fewer of the pictured components.

### CONCLUSION

Example embodiments of the disclosed innovations have been described above. Those skilled in the art will understand, however, that changes and modifications may be made to the embodiments described without departing from the true scope and spirit of the present invention, which will be defined by the claims.

Further, to the extent that examples described herein involve operations performed or initiated by actors, such as “humans,” “operators,” “users,” or other entities, this is for purposes of example and explanation only. The claims should not be construed as requiring action by such actors unless explicitly recited in the claim language.

1. A computing platform comprising:
at least one processor;
at least one non-transitory computer-readable medium; and
program instructions stored on the at least one non-transitory computer-readable medium that, when executed by the at least one processor, cause the computing platform to:
create a fraud identification model for identifying fraudulent applications by:
obtaining information for a plurality of processed applications for opening respective financial accounts with a financial institution, wherein the obtained information comprises a respective set of attributes for each processed application;
creating a knowledge graph to represent linkages between the plurality of processed applications and the respective sets of attributes, wherein the knowledge graph comprises (i) a respective application node for each of the plurality of processed applications, (ii) a respective attribute node for each distinct attribute that is included in the respective sets of attributes and (iii) one or more a plurality of application-to-attributes edges connecting the respective application nodes to the respective attribute nodes;
transforming the knowledge graph by:
performing an analysis of the knowledge graph to determine shared attributes between respective pairs of the respective application nodes;
adding a respective application-to-application edge between each respective pair of the respective application nodes that represents an aggregation of the determined shared attributes between the respective pair of the respective application nodes; and
removing the respective attribute nodes and the plurality of application-to-attribute edges from the knowledge graph;
performing an analysis of the transformed knowledge graph and thereby generating feature data for the respective application nodes;
performing an analysis of the transformed knowledge graph for patterns that are indicative of fraud rings and thereby identifying groups of respective application nodes within the transformed knowledge graph that are associated with fraud rings;
for each identified group of respective application nodes associated with a fraud ring, generating fraud ring-specific feature data for the identified group; and
training the fraud identification model based on (i) the transformed knowledge graph, (ii) the generated feature data for the respective application nodes, and (iii) the generated fraud ring-specific feature data for the identified groups of respective application nodes; and
after creating the fraud identification model, process an additional set of applications for opening respective financial accounts with the financial institution by:
obtaining information for the additional set of applications;
based on the obtained information for the additional set of applications, updating the transformed knowledge graph to (i) include additional application nodes for the additional set of applications and (ii) represent linkages between the additional application nodes and the respective application nodes for the plurality of processed applications that are included within the transformed knowledge graph;
based on (i) the trained fraud identification model and (ii) the updated. transformed knowledge graph, determining that a given application of the additional set of applications is a fraudulent application; and
in response to determining that that the given application is a fraudulent application, automatically declining the given application.

2. (canceled)

3. (canceled)

4. The computing platform of claim 1, wherein the updated, transformed knowledge graph comprises a first updated, transformed knowledge graph, and wherein the computing platform further comprises program instructions stored on the at least one non-transitory computer-readable medium that, when executed by the at least one processor, cause the computing platform to:
after training the fraud identification model, perform at least one of (i) updating the transformed knowledge graph based on additional processed applications and thereby generating a second updated, transformed knowledge graph, (ii) generating updated feature data for the respective application nodes, or (iii) generating updated fraud ring-specific feature data for the identified groups of respective application nodes; and
thereafter retrain the fraud identification model based on at least one of the generated second updated, transformed knowledge graph, the generated updated feature data for the respective application nodes, or the generated updated fraud ring-specific feature data for the identified groups of respective application nodes.

5. The computing platform of claim 1, wherein the obtained information for the plurality of processed applications further comprises, for each of the processed applications, a respective decision status indication of whether the processed application has been declined or approved.

6. The computing platform of claim 5, wherein the feature data for the respective application nodes is generated based on the decision status indications for the processed applications.

7. The computing platform of claim 1, wherein the fraud identification model comprises a set of rules for identifying new fraud applications.

8. The computing platform of claim 1, further comprising program instructions stored on the at least one non-transitory computer-readable medium that, when executed by the at least one processor, cause the computing platform to:
store the knowledge graph in memory;
wherein transforming the knowledge graph comprises transforming the knowledge graph within memory; and
wherein updating the transformed knowledge graph comprises updating the transformed knowledge graph within memory.

9. (canceled)

10. A non-transitory computer-readable medium, wherein the non-transitory computer-readable medium is provisioned with program instructions that, when executed by at least one processor, cause a computing platform to:
create a fraud identification model for identifying fraudulent applications by:
obtaining information for a plurality of processed applications for opening respective financial accounts with a financial institution, wherein the obtained information comprises a respective set of attributes for each processed application;
creating a knowledge graph to represent linkages between the plurality of processed applications and the respective sets of attributes, wherein the knowledge graph comprises (i) a respective application node for each of the plurality of processed applications, (ii) a respective attribute node for each distinct attribute that is included in the respective sets of attributes and (iii) a plurality of application-to-attributes edges connecting the respective application nodes to the respective attribute nodes;
transforming the knowledge graph by:
performing an analysis of the knowledge graph to determine shared attributes between respective pairs of the respective application nodes;
adding a respective application-to-application edge between each respective pair of the respective application nodes that represents an aggregation of the determined shared attributes between the respective pair of the respective application nodes; and
removing the respective attribute nodes and the plurality of application-to-attribute edges from the knowledge graph;
performing an analysis of the transformed knowledge graph and thereby generating feature data for the respective application nodes;
performing an analysis of the transformed knowledge graph for patterns that are indicative of fraud rings and thereby identifying groups of respective application nodes within the transformed knowledge graph that are associated with fraud rings;
for each identified group of respective application nodes associated with a fraud ring, generating fraud ring-specific feature data for the identified group; and
training the fraud identification model based on (i) the transformed knowledge graph, (ii) the generated feature data for the respective application nodes, and (iii) the generated fraud ring-specific feature data for the identified groups of respective application nodes; and
after creating the fraud identification model, process an additional set of applications for opening respective financial accounts with the financial institution by:
obtaining information for the additional set of applications;
based on the obtained information for the additional set of applications, updating the transformed knowledge graph to (i) include additional application nodes for the additional set of applications and (ii) represent linkages between the additional application nodes and the respective application nodes for the plurality of processed applications that are included within the transformed knowledge graph;
based on (i) the trained fraud identification model and (ii) the updated, transformed knowledge graph, determining that a given application of the additional set of applications is a fraudulent application; and
in response to determining that that the given application is a fraudulent application, automatically declining the given application.

11. (canceled)

12. (canceled)

13. The non-transitory computer-readable medium of claim 10, wherein the updated, transformed knowledge graph comprises a first updated, transformed knowledge graph, and wherein the non-transitory computer-readable medium is further provisioned with program instructions that, when executed by at least one processor, cause the computing platform to:
after training the fraud identification model, perform at least one of (i) updating the transformed knowledge graph and thereby generating a second updated, transformed knowledge graph, (ii) generating updated feature data for the respective application nodes, or (iii) generating updated fraud ring-specific feature data for the identified groups of respective application nodes; and
thereafter retrain the fraud identification model based on at least one of the generated second updated, transformed knowledge graph, the generated updated feature data for the respective application nodes, or the generated updated feature data for the identified groups of respective application nodes.

14. The non-transitory computer-readable medium of claim 10, wherein the obtained information for the plurality of processed applications further comprises, for each of the processed applications, a respective decision status indication of whether the processed application has been declined or approved.

15. The non-transitory computer-readable medium of claim 14, wherein the feature data for the respective application nodes is generated based on the decision status indications for the processed applications.

16. The non-transitory computer-readable medium of claim 10, wherein the fraud identification model comprises a set of rules for identifying new fraud applications.

17. The non-transitory computer-readable medium of claim 10, wherein the non-transitory computer-readable medium is also provisioned with program instructions that, when executed by at least one processor, cause the computing platform to:
store the knowledge graph in memory;
wherein transforming the knowledge graph comprises transforming the knowledge graph within memory; and
wherein updating the transformed knowledge graph comprises updating the transformed knowledge graph within memory.

18. (canceled)

19. A method implemented by a computing platform, the method comprising:
creating a fraud identification model for identifying fraudulent applications by:
obtaining information for a plurality of processed applications for opening respective financial accounts with a financial institution, wherein the obtained information comprises a respective set of attributes for each processed application;
creating a knowledge graph to represent linkages between the plurality of processed applications and the respective sets of attributes, wherein the knowledge graph comprises (i) a respective application node for each of the plurality of processed applications, (ii) a respective attribute node for each distinct attribute that is included in the respective sets of attributes and (iii) a plurality of application-to-attributes edges connecting the respective application nodes to the respective attribute nodes;
transforming the knowledge graph by:
performing an analysis of the knowledge graph to determine shared attributes between respective pairs of the respective application nodes;
adding a respective application-to-application edge between each respective pair of the respective application nodes that represents an aggregation of the determined shared attributes between the respective pair of the respective application nodes; and
removing the respective attribute nodes and the plurality of application-to-attribute edges from the knowledge graph;
performing an analysis of the transformed knowledge graph and thereby generating feature data for the respective application nodes;
performing an analysis of the transformed knowledge graph for patterns that are indicative of fraud rings and thereby identifying groups of respective application nodes within the transformed knowledge graph that are associated with fraud rings;
for each identified group of respective application nodes associated with a fraud ring, generating fraud ring-specific feature data for the identified group; and
training the fraud identification model based on (i) the transformed knowledge graph, (ii) the generated feature data for the respective application nodes, and (iii) the generated fraud ring-specific feature data for the identified groups of respective application nodes; and
after creating the fraud identification model, processing an additional set of applications for opening respective financial accounts with the financial institution by:
obtaining information for the additional set of applications;
based on the obtained information for the additional set of applications, updating the transformed knowledge graph to (i) include additional application nodes for the additional set of applications and (ii) represent linkages between the additional application nodes and the respective application nodes for the plurality of processed applications that are included within the transformed knowledge graph;
based on (i) the trained fraud identification model and (ii) the updated, transformed knowledge graph, determining that a given application of the additional set of applications is a fraudulent application; and
in response to determining that that the given application is a fraudulent application, automatically declining the given application.

20. (canceled)

21. The computing platform of claim 1, wherein the obtained information for the plurality of processed applications further comprises portfolio information for the plurality of processed applications, and wherein the feature data for the respective application nodes is generated based on the obtained portfolio information for the plurality of processed applications.

22. The computing platform of claim 1, wherein the program instructions that, when executed by the at least one processor, cause the computing platform to process the additional set of applications comprise further program instructions that, when executed by the at least one processor, cause the computing platform to process the additional set of applications by:
performing an analysis of the updated, transformed knowledge graph and thereby generating feature data for the additional application nodes; and
generating updated fraud ring-specific feature data for the identified groups of respective application nodes,
wherein determining that the given application of the additional set of applications is a fraudulent application based on the trained fraud identification model and the updated, transformed knowledge graph comprises determining that the given application of the additional set of applications is a fraudulent application by applying the trained fraud identification model to the generated feature data for the additional application nodes and the generated updated fraud ring-specific feature data for the identified groups of respective application nodes.

23. The computing platform of claim 1, wherein the generated fraud ring-specific feature data for a given identified group of respective application nodes comprise at least one of (i) an indication of an amount of the respective application nodes within the given identified group that share a first given attribute in common but that do not share a second given attribute in common, (ii) an indication of a ratio of declined applications to approved applications that are represented within the given identified group of respective application nodes, or (iii) an indication of how often processed applications represented within the given identified group of respective application nodes are submitted using a same given attribute.

24. The computing platform of claim 1, wherein the trained fraud identification model is configured to output predictions as to whether given applications are fraudulent applications.

25. The method of claim 19, further comprising:
storing the knowledge graph in memory;
wherein transforming the knowledge graph comprises transforming the knowledge graph within memory; and
wherein updating the transformed knowledge graph comprises updating the transformed knowledge graph within memory.

26. The method of claim 19, wherein the trained fraud identification model is configured to output predictions as to whether given applications are fraudulent applications.

27. The method of claim 19, wherein the trained fraud identification model comprises a set of rules for identifying new fraud applications.
